(19) United States
(12) Patent Application Publication
(10) Pub. No.: US 2018/0276537 A1
(43) Pub. Date: Sep. 27, 2018

(54) Neural Architectures and Systems and Methods of Their Translation

(71) Applicant: The Charles Stark Draper Laboratory, Inc., Cambridge, MA (US)

(72) Inventors: Richard Joseph Wood, Derry, NH (US); Brent Hollosi, Cambridge, MA (US); Robert D'Angelo, Cambridge, MA (US); Wes Uy, Cambridge, MA (US); Geremy Freifeld, Cambridge, MA (US); Nathan Lowry, Cambridge, MA (US); Haiyao Huang, Cambridge, MA (US); Dorothy Carol Poppe, Cambridge, MA (US); Christopher Salthouse, Cambridge, MA (US)

(21) Appl. No.: 15/927,347

(22) Filed: Mar. 21, 2018

Related U.S. Application Data
(60) Provisional application No. 62/474,353, filed on Mar. 21, 2017.

(51) Int. Cl. G06N 3/063; G06N 3/04

(52) U.S. Cl. CPC G06N 3/0635; G06N 3/04

(57) ABSTRACT

A method and a system for implementing a mathematical algorithm in a neural architecture and transferring that neural architecture to an integrated circuit (IC) chip. The neural architecture has neurons that are capable of converting current to frequency, voltage to frequency, frequency to frequency and time to frequency. The neurons can have multi-sensor inputs (multiple synapses) for either scaling or inhibiting neuron outputs. The neural architecture-to-hardware conversion method is specifically tailored for neural architectures for image processing applications.

### RELATED APPLICATIONS

This application claims the benefit under 35 USC 119(e) of U.S. Provisional Application No. 62/474,353 filed on Mar. 21, 2017, which is incorporated herein by reference in its entirety.

### BACKGROUND OF THE INVENTION

Artificial Neural Network (ANN) is a computational model (algorithm) based on the neuron model of the human brain. A simple model of a neuron has one or more input nodes (input layer), followed by computer processing (in a hidden layer), which leads to one or more output nodes (output layer). Neurons can be connected to each other and to inputs via synapses in a human nervous system. ANN is a simplified abstraction of its biological counterpart, biological neural network (BNN). In ANN, synapses are weights given to an input node. Thus the value of synapse weight is a measure of the strength of the contribution of the corresponding input in determining the output nodes.

ANNs are widely used for machine learning such as stock market prediction, character recognition, speech recognition, threat recognition, machine vision (also known as computer vision), image compression, etc., to name just a few applications. In general, neural networks are useful for modeling scenarios where the input-output relationship follows complicated patterns which are difficult to visualize and model.

The importance of the role of neurons in human vision is readily apparent when one compares current computer-based image processing systems to the way humans interpret image stimulations (i.e., visible light). Human vision is almost instantaneous upon receiving light whereas computer image processing is much slower. In computer image processing, acquired data must be off-loaded to a processor external to the focal plane array for processing. On the other hand, if the pixels in a focal plane array could perform some basic image processing tasks, it would go a long way toward making machine vision approach the speed of human vision. This capability of pixels in a focal plane array would amount to pixels behaving, in a rough approximation, like the neurons responsible for human vision. A neuromorphic focal plane array would be such a focal plane array

Similarly, speech recognition using computers can potentially be accelerated by orders of magnitude if sound signals can be analyzed (at least partially) at the sensor level without post-processing using external processors.

### SUMMARY OF THE INVENTION

This invention concerns neural architectures and systems. In one example, they could be part of a neuromorphic focal plane array capable of real time vision processing.

The invention describes methods by which a mathematical algorithm is realized in a neural network architecture and then instantiated in neuromorphic circuits and hardware for processing information. “Neuromorphic” here denotes that elements of the network and its physical realization (i.e., circuit or hardware) behave like biological neurons since they accept inputs and process them into intermediate outputs at the neuron level in real-time or near real-time.

In addition to computer vision, such architectures can be used for sound processing also. However, the emphasis in this invention is on neuromorphic pixels and focal plane arrays of pixels.

This invention shows neuromorphic models of pixels and operations of pixel arrays, and presents a method for translating them into a circuit board.

In general, according to one aspect, the invention disclosed here describes a method and a system for implementing a mathematical algorithm as a neural architecture and realizing that architecture on an integrated circuit (IC) chip. The neural architecture has neurons that are capable converting current to frequency, voltage to frequency, frequency to frequency and time to frequency. The neurons can have multi-sensor (multiple synapses) inputs for either scaling an inhibiting neuron outputs.

The mathematical algorithm-to-neural architecture-to-hardware conversion method and system is general in nature but has been specifically demonstrated on mathematical algorithms designed for image processing applications.

In general, according to another aspect, the invention features neuromorphic system for processing signals from a sensor. The system comprises a synapse and a neuron that receives a current from the synapse and produces a frequency output.

Preferably, the synapse is controlled by a bias voltage. It might receive a current from a photodetector.

In some examples, the synapse or neuron is controlled by a second sensor. Also, multiple synapses can feed into the same neuron.

In embodiments, the neuron comprises a capacitor that is charged by the current from the synapse. A comparator then compares the voltage on the capacitor to a threshold voltage and resets the capacitor based on a comparison of the threshold voltage with the voltage of the capacitor.

To process information from an image sensor, frequency outputs from multiple neurons are collected to perform a convolution.

In general, according to another aspect, the invention features a method for embedding in an integrated circuit chip a neuromorphic architecture. The method comprises providing multiple neuromorphic circuit elements and performing a convolution with the circuit elements.

In general, according to another aspect, the invention features a method of embedding a mathematical algorithm into a neuromorphic architecture. The method comprises providing a desired algorithm, and generating a hardware-optimized algorithm, generating a neuron-optimized algorithm, and providing a Verilog description of chip design obtained from neural network definition of neuron-optimized algorithm, which in turn is obtained from the hardware-optimized algorithm.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A is a circuit diagram showing an LIF neuron model with notional timing diagrams in FIG. 1B (capacitor voltage) and FIG. 1C (output voltage).

FIG. 2 is a circuit diagram showing current to frequency mode conversion (type 1) using a LIF neuron.

FIG. 3 is a circuit diagram showing voltage to frequency mode conversion (type 2) using a LIF neuron.

FIG. 4A is a circuit diagram showing frequency-to-frequency mode conversion (type 3) using a LIF neuron with notional voltage timing diagrams in FIG. 4B (capacitor) and FIG. 4C (output).

FIG. 5 is a circuit diagram showing time to frequency mode conversion (type 4) using a LIF neuron.

FIG. 6 is a circuit diagram showing a multi-sensor, e.g., light and sound sensors, LIF neuron configuration.

FIG. 7A is a circuit diagram showing how one sensor can augment (scale) a second sensor.

FIG. 7B is a circuit diagram showing how one sensor can compete against or inhibit the output of a second sensor.

FIG. 8 is a circuit diagram showing weighted addition of two inputs in frequency-mode addition.

FIG. 9 is a schematic diagram shows a simplified model of frequency-mode addition.

FIG. 10 is a schematic diagram a representation of 3×3 convolution using simplified frequency-mode addition diagram (FIG. 9).

FIG. 11 shows the steps involved in implementing mathematical neural algorithms on neuromorphic hardware.

FIG. 12 shows how a tree of 2 synapse neuron can replicate the function of a single 9 synapse neuron.

FIG. 13 shows the pixel numbering system for a 2-D image.

FIGS. 14A-14H shows image pixels and “extra pixels” for 3×3 convolution of side and corner pixels

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

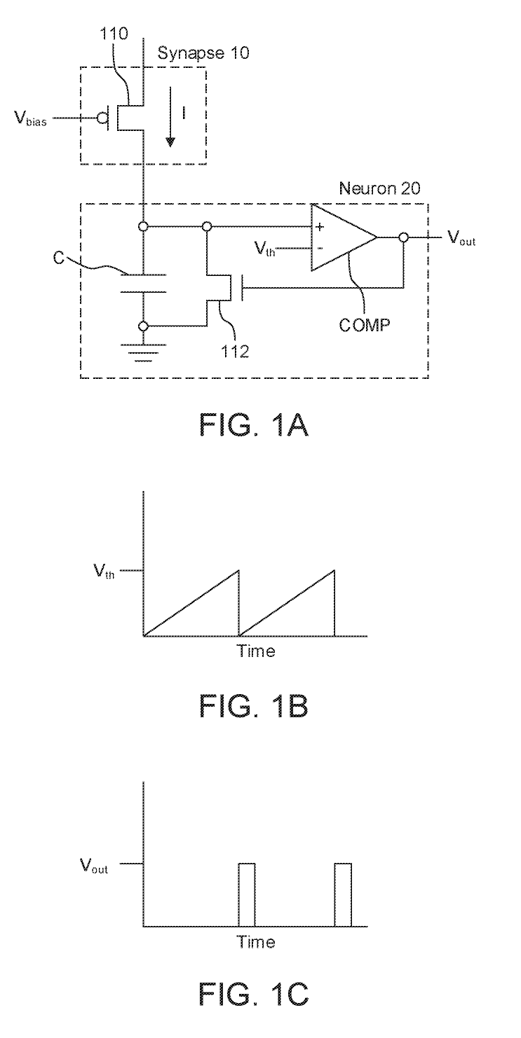

The basic element is a linear integrate-and-fire (LIF) neuron as exhibited in FIG. 1A. It is comprised of a synapse 10 and a neuron 20. The synapse is comprised of a FET (Field Effect Transistor) 110 or series of FETs; the bias voltage V_{bias} controls the current flow I in the synapse 10. The neuron is comprised of an integrating capacitor C, comparator COMP, and reset FET 112. Basic operation involves current I, typically from some type of sensor, such as a photodetector, charging the capacitor through the synapse. Once the top plate of capacitor C reaches a threshold voltage, Vₜₕ, the comparator COMP fires (a burst of fixed intensity and duration) as shown in the notional timing diagrams FIGS. 1B (for capacitor) and 1C (for output voltage Vₒᵤₜ). This event can be used to propagate information and reset the capacitor voltage allowing subsequent integrate-and-fire cycles to occur.

This LIF node is capable of several types of data processing and transformations depending on the synapse's gate and source stimulus and the comparator's configuration. Furthermore, the synapse enables weighting of the integrated charge through numerous methods, e.g., FET width scaling, multiple synaptic paths, and adaptable gate voltage bias via wired control or programmable floating-gate. This can be used to perform scalar or non-linear functions allowing for features like per-neuron gain control or more complex mathematical operations like logarithmic transformations.

In summary, the core LIF node has several interesting characteristics: 1) Capability to process voltage, current, frequency, or time information, 2) Output in frequency or time, 3) Direct interface with digital logic or subsequent LIF stages enabling further quantization or computation, 4) Input scaling via synapse modulation, 5) Linear or non-linear input-to-output relationship (as configured,) and 6) Very low power consumption.

When applied to large sensor systems, such as image sensors, this node can provide a variety of valuable features: 1) Low power data conversion between sensors and digital layer, 2) Reconfigurable synaptic modulation for real-time scaling changes, 3) Multi-modal processing—processing multiple sensor streams at the same time, and 4) Low power pre-processing, e.g., 2-D convolution, multiplication/division, saliency.

Data Conversion Capabilities of LIF:

Although the output of LIF neurons is frequency (voltage spikes per sec), its input can be current, voltage, frequency or time since the inputs are mathematically related as discussed below.

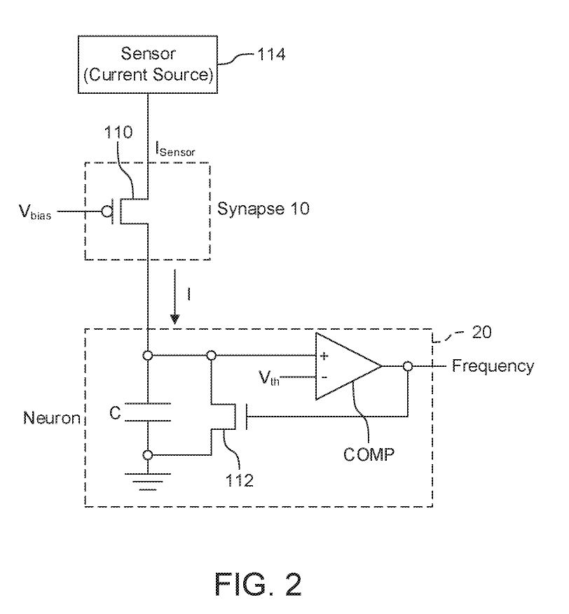

Type 1 Current to Frequency (FIG. 2):

In this mode, shown in FIG. 2, a sensor 114 provides current information input Iₛₑₙₛₒᵣ to the synapse 10 from which it emerges as current I. I is integrated onto the capacitor C. When the capacitor voltage reaches Vu, the comparator COMP will produce a fixed-width pulse. In this way, the comparator produces fixed-width pulses at a rate proportional to the supplied current making the output a frequency-coded representation of the sensor current. Sensor current is scaled from 0 to 1 based on the drain current of the synapse which is controlled by V_{bias}, which may be an analog value or a frequency/time coded signal. The mechanics of this interaction are governed by Eq. 1 (C=capacitance; I=current) where the smaller current is chosen to keep the frequency in an acceptable range.

$$Type 1 \text{:} frequency = \frac{I}{C * {V}_{th}} , I = min \{ {I}_{sensor} , {I}_{synapse} \} \qquad Eq . ( 1 )$$

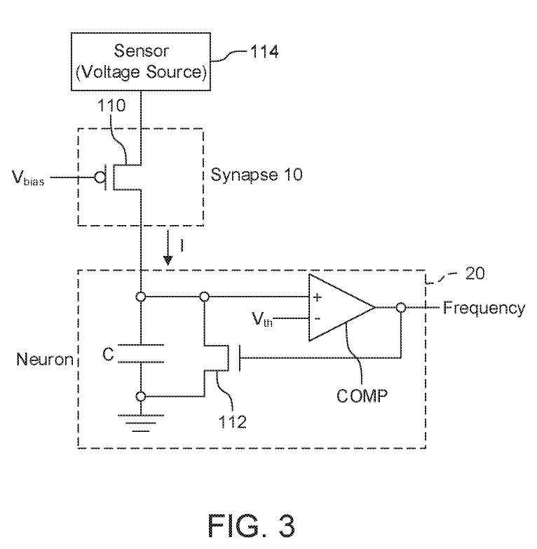

Type 2 Voltage to Frequency (FIG. 3):

In this mode, a sensor 114 provides voltage information which produces the integrated current modulated by the resistance of the synapse. A depiction is given in FIG. 3 with the governing equation in Eq. 2 (R_{synapse}=resistance of the synapse).

$$Type 2 \text{:} frequency = \frac{I}{C * {V}_{th}} , I = \frac{{V}_{sensor}}{{R}_{synapse}} \qquad Eq . ( 2 )$$

Because of the voltage source, more current scaling options are able to be employed, e.g., FET widening and multiple synaptic paths per input. This allows current gains greater than 1 to be achieved.

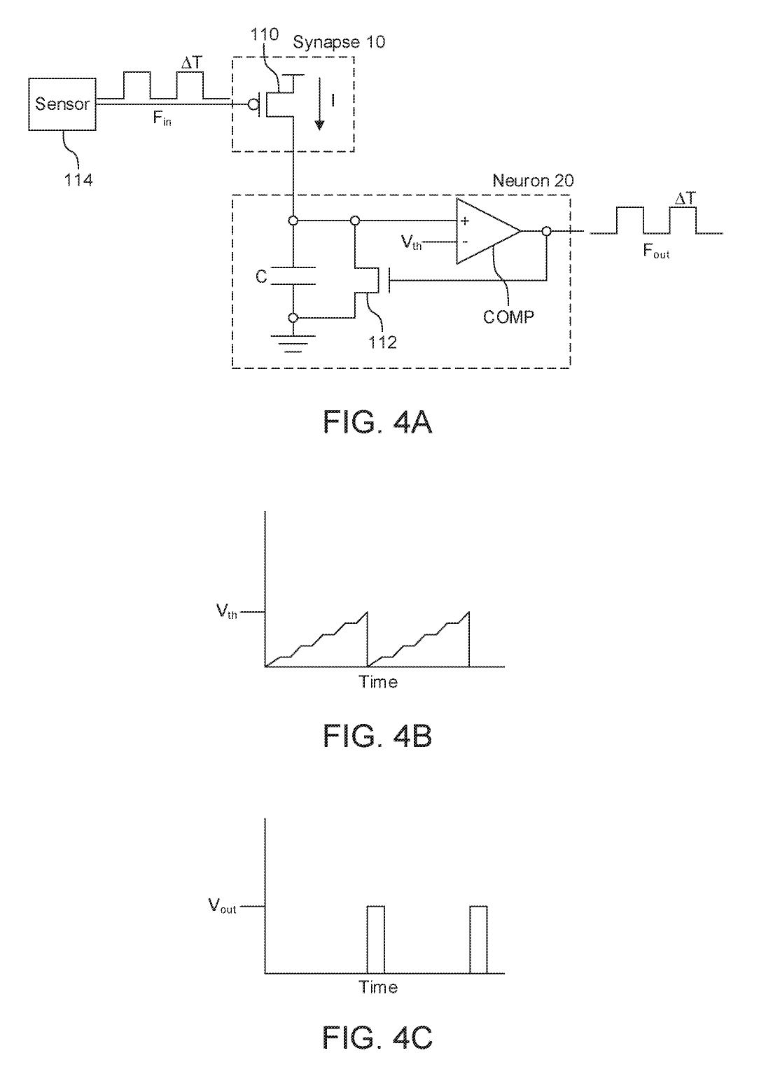

Type 3 Frequency to Frequency (FIGS. 4A-4C):

In this mode, the voltage source 114 of the synapse is fixed, and fixed-width pulse trains Fᵢₙ are used to stimulate the synaptic channel. The comparator COMP and reset FET 112 are tuned to generate equivalently sized pulse widths upon firing. An example circuit (FIG. 4A) and notional charging (FIG. 4B) and output (FIG. 4C) depictions are shown in FIG. 4A. The integrate-and-fire mechanics are governed by Eq. 3, where Fᵢₙ is input frequency and left hand side (LHS) is output frequency, dented by Fₒᵤₜ. Note that Fᵢₙ and Fₒᵤₜ are not the same as both the comparator (COMP) and the synapse 10 modulate the firing rate; the pulse widths ΔT are fixed but the presence or absence of a pulse is dependent upon the input frequency.

$$Type 3 \text{:} frequency = \frac{I * Δ T}{C * {V}_{th}} * {F}_{in} \qquad Eq . ( 3 )$$

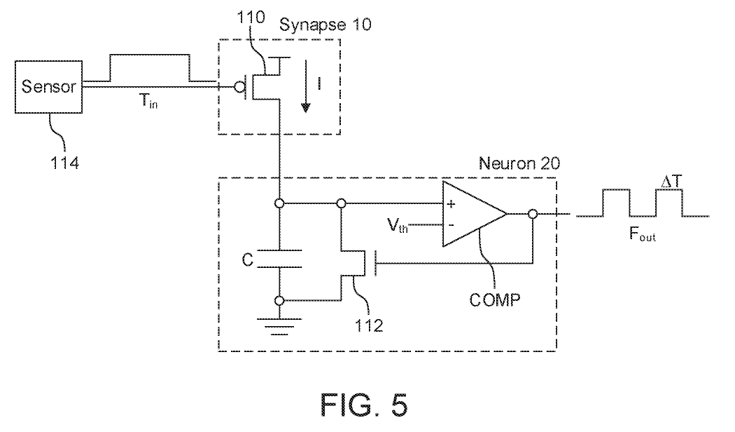

Type 4 Time to Frequency (FIG. 5):

This mode differs from the Type 3 mode only in that the input is time Tᵢₙ rather than frequency. An example is given in FIG. 5 with the governing equation in Eq. 4.

$$Type 4 \text{:} frequency = \frac{I * {T}_{in}}{C * {V}_{th}} \qquad Eq . ( 4 )$$

Output Scaling:

From Eq. 1, frequency can be independently scaled on a per-pixel basis via synapse current and/or Vₜₕ (COMP threshold) modulation. Synapse current can be modulated by V_{bias} and/or additional sink or source paths depending on whether the synapse is current or voltage sourced, respectively. Current-sourced synapses allow for a current scaling factor from 0 to 1. Voltage-sourced synapses allow for current scaling factors greater than 1. Vₜₕ modulation works as an independent scale factor linearly affecting the output frequency.

Multi-Sensor Processing:

To summarize information presented thus far, the core LIF node is capable of operating on a wide range of information types. Any combinations of voltage/current/frequency/time to frequency/time processing is achievable through configurations of the synapse and neuron. Furthermore, since the integration mechanism is the same for all modes, additional synaptic pathways controlled by disparate (or similar) sensor types can be added. These additional pathways will operate according to Kirchoff's current laws enabling multi-sensor interaction.

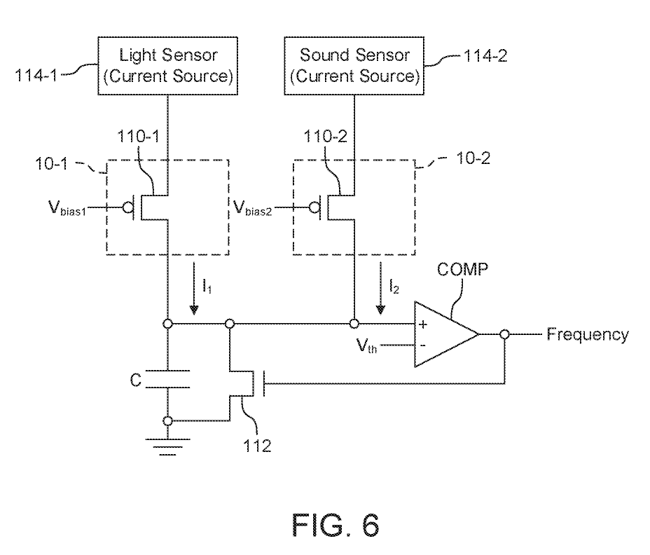

An example is shown in FIG. 6. Two disparate sensors 114-1 (light sensor) and 114-2 (sound sensor) both produce current information I1 (synapse FET 110-1) and I2 (synapse FET 110-2), through their synapses 10-1 and 10-2, integrated onto the same capacitor C. By Kirchoff's current laws, the comparator's frequency output is now proportional to the sum of these scaled currents as shown in Eq. 5. The scale factors (controlled by V_{bias1} and V_{bias2}), each between 0 and 1, can be used to indicate which sensor's data stream is more impactful. Note that FIG. 6 is a generalization of FIG. 2 for multiple sensors.

$$frequency = \frac{{s}_{1} * {I}_{1} + {s}_{2} * {I}_{2}}{C * {V}_{th}} , {s}_{1} and {s}_{2} = ( 0 , 1 ) \qquad Eq . ( 5 )$$

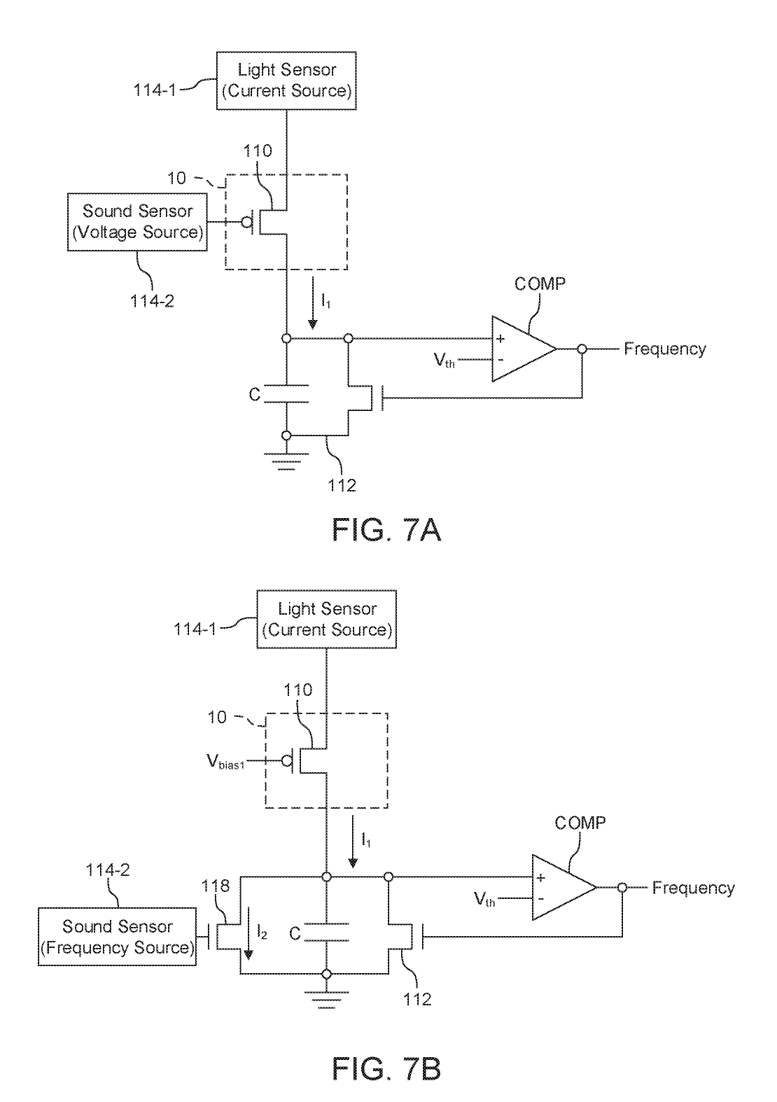

A sensor stream can be used to scale or directly compete against another stream as exemplified by the two images of FIGS. 7A and 7B.

In FIG. 7A, the voltage output of the sound sensor 114-2, like V_{bias} of FIG. 2, scales the current contribution of light sensor 114-1. The resulting scaled I1 charges the capacitor C as described in FIGS. 1 and 2.

In FIG. 7B, the current information of sound sensor 114-2 (though FET 118) inhibits the comparator's firing creating a scenario where the light sensor 114-1 must outdrive the sound sensor 114-2 to produce a firing event.

The above examples show that several linear operations, e.g., addition, subtraction, and scaling, are directly realizable via LIF variations. These operations form the foundation of 2-D convolution, a common pre-processing step to a large variety of algorithms and a near-ubiquitous step in imaging applications.

Pre-Processing Computation:

Linear, Frequency Mode:

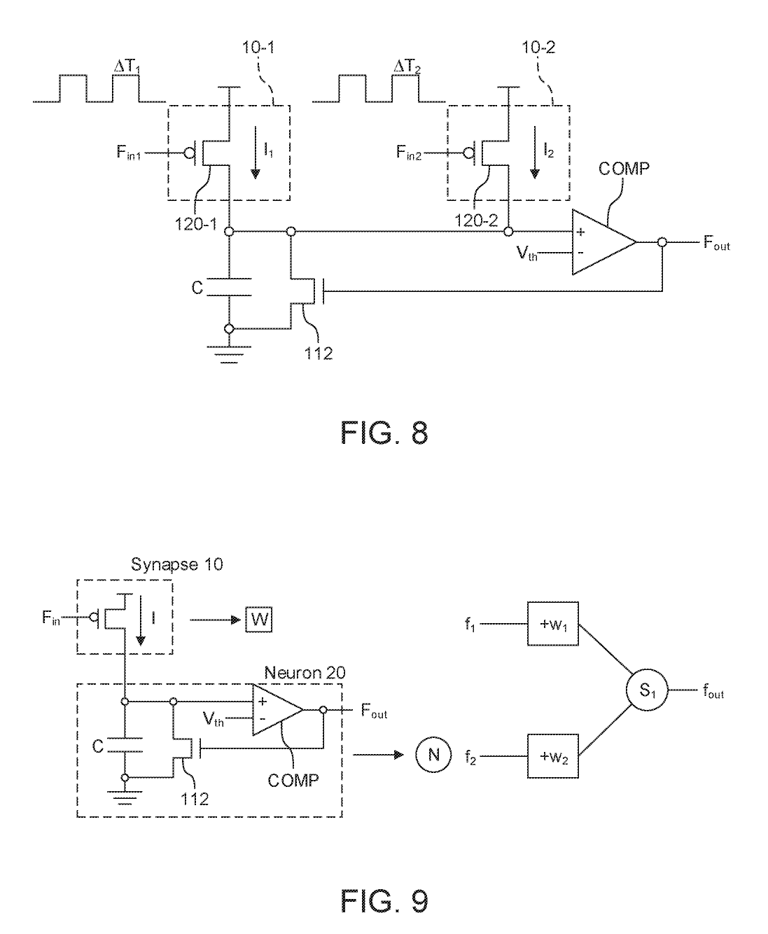

FIG. 8, a generalization of FIG. 4A, details the configuration for a weighted, two-input frequency-mode addition. Two synapses 10-1 and 10-2, with FET 120-1 and FET 120-2, combine to drive the capacitor C. The synapses produce I₁ and I₂ from the same bias current I_{b} using two different weights w₁ and w₂ as shown in Eq. 6 below.

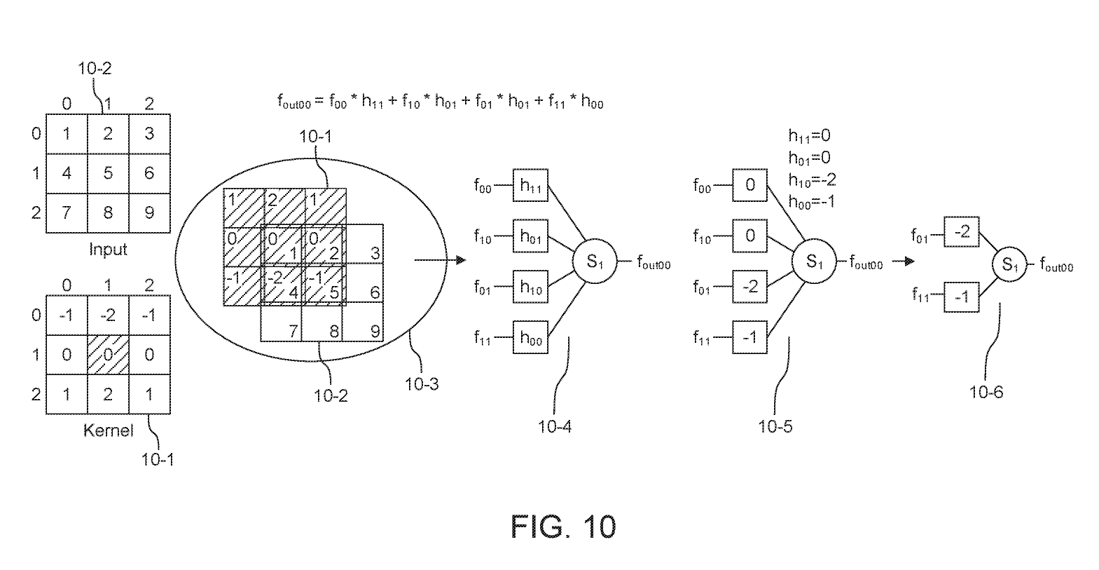

Eqs. 6 through 9 detail the mechanics of this operation. As is shown, Fₒᵤₜ is proportional to the weighted sum of Fᵢₙ₁ and Fᵢₙ₂ multiplied by a scaling factor. To allow easier handling of the equations, this operation can be modeled more simply with Eqs. 10 and 11. This simpler model is depicted in FIG. 9, in which N represents Neuron. The synapse weights are w1 and w2 on the right. ‘f1’ and ‘f2’ represent incoming firing rates from other neurons. FIG. 10 shows an example computation step of a 3×3 2-D convolution.

$$\begin{matrix}{I}_{1} = {w}_{1} * {I}_{b} \\ {I}_{2} = {w}_{2} * {I}_{b} & Eq . ( 6 ) \\ Δ {T}_{1} = {wt}_{1} * Δ {T}_{b} \\ Δ {T}_{2} = {wt}_{2} * Δ {T}_{b} & Eq . ( 7 ) \\ {F}_{out} = \frac{{I}_{1} * Δ {T}_{1} * {F}_{in 1} + {I}_{2} * Δ {T}_{2} * {F}_{in 2}}{C * {V}_{th}} & Eq . ( 8 ) \\ {F}_{out} = [ \frac{{I}_{b} * Δ {T}_{b}}{C * {V}_{th}} ] * ( {w}_{1} * {wt}_{1} * {F}_{in 1} + {w}_{2} * {wt}_{2} * {F}_{in 2} ) & Eq . ( 9 ) \\ {S}_{1} = \frac{{I}_{b} * Δ {T}_{b}}{C * {V}_{th}} ; {f}_{1} = {wt}_{1} * {F}_{in 1} ; {f}_{2} = {wt}_{2} * {F}_{in 2} & Eq . ( 10 ) \\ {f}_{out} = \frac{{w}_{1} * {f}_{1} + {w}_{2} * {f}_{2}}{{S}_{1}} & Eq . ( 11 )\end{matrix}$$

FIG. 10 shows a convolution window 10-1 of size 3×3 with the convolution weights indicated in each of the squares. An arbitrary window of an image is shown in 10-2. 10-3 show the convolution process where the window positioned on a corner pixel of the image. The corner pixel is at the center of 10-1 as shown in 10-3. 10-4 and 10-5 are neural diagrams of the convolution implementation with weight from four image pixels. 10-6 shows the final diagram with only two inputs to neuron as two of the four weights of the convoluting window equal zero.

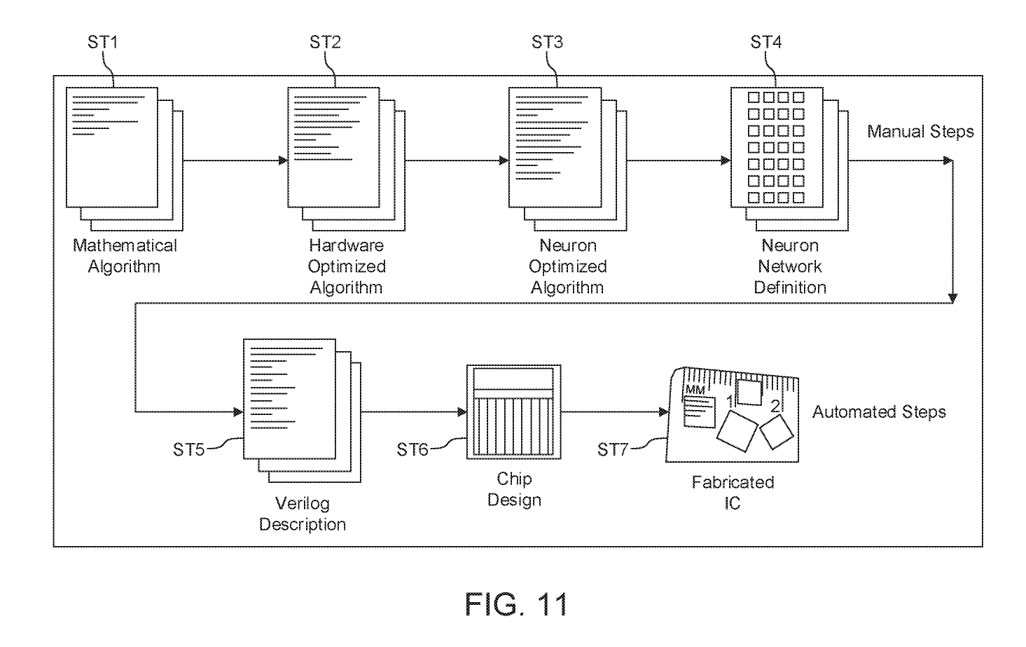

In addition, a mathematical algorithm can be identified and implemented in neuromorphic hardware. The key components of this process are shown in FIG. 11. Those components are: the mathematical algorithm ST1 to be instantiated in neuromorphic hardware, the hardware-optimized version of the algorithm ST2, the neuron-optimized algorithm ST3, a neural network definition ST4, the Verilog description ST5 of the algorithm, the chip design ST6, and the final neuromorphic hardware (Fabricated IC) ST7. The first four steps, ST1, ST2, ST3, and ST4 are currently highly manual steps but are envisioned to be automated in the future.

The mathematical algorithm ST1 can be provided in a variety of forms, but preferably in some high-level language such as Matlab. Once the high level algorithm is defined, the hardware optimization begins by identifying functional pieces of the algorithm that may not be amenable to hardware implementations. In the current process this is done by manually but in the preferred embodiment automated tools assist in this identification process. Certain mathematical processes, such as argmax, which denote the input value where a function is maximum, or more complex mathematical functions (e.g., von Mises distributions, Bessel functions, etc.) do not lend themselves to straight forward hardware implementations. At this stage, they are replaced with hardware “friendly” approximations or substituted by simpler functions that retain the key aspects of the algorithm (for instance substituting the L1 norm for an L2 norm). The result of this step ST2 is the hardware-optimized algorithm.

The disclosed neuromorphic hardware affords unique advantages in terms of power savings and computational performance. To provide the best performance of the hardware-optimized algorithm in the neuromorphic hardware, the next step looks at where in the hardware-optimized algorithm one can get further optimizations based on the performance characteristics of the neurons themselves. This can take the form of identifying areas in the algorithms that can take advantage of reduced precision computation (i.e., such as quantizing kernel weights) and time-mode processing inherent in neural systems. The result is a neuron-optimized version ST3 of the mathematical algorithm.

The translation from the neuron-optimized code to the neural network definition involves taking that neuron-optimized code and expanding on the capabilities of neuromorphic computing by performing calculations through chains of synthetic neurons, thereby increasing the number of inputs to the system beyond the limiting number of synapses. A detailed description of this process with a specific example is discussed with respect to scaling below. This results in a neural network definition ST4 that can be realized on neuromorphic hardware.

The translation of the neural network definition to the Verilog description ST5 begins the automated process of implementing the algorithm in hardware. The neural network definition is similar to a netlist. The Verilog tools take that netlist and translate it to a Verilog description ST5 which is reviewed and modified to produce a chip design ST6 in adherence to fabrication rules. That chip design is then fabricated resulting in a fabricated IC chip ST7 that has analog neuromorphic circuitry that implements the original mathematical algorithm.

Most techniques try to go directly from the mathematical algorithm to neuromorphic hardware without being fully optimized. Opportunities for optimization may be missed by not performing the first four steps of the process of FIG. 11.

Others have tried to solve the problem, but their fundamental approach is different in that their approach is either all digital or mixed signal. Furthermore, they tend to go directly from the algorithm to hardware without searching for possible areas for optimization.

The analog neuromorphic hardware affords power savings and computational power that other approaches (digital, mixed signal) do not have. This affords opportunities for implementing algorithms in this analog neuromorphic that other approaches do not have. Thus, the first four steps, while manual, affords us optimizations that other approaches do not.

Scaling:

Currently, one neuron with a set number of synapses is used to perform one calculation, such as the 2-D convolution with a 3×3 kernel. For convolution, a neuron with 9 synapses is used, one for each element of the kernel. However, in some cases, the number of inputs to a system will outnumber the synapses of the available neuron. In order to expand on the capabilities of neuromorphic computing, calculations are performed through chains of synthetic neurons, thereby increasing the number of inputs to the system beyond the limiting number of synapses. Here a methodology is introduced to implement this. As a test case, the methodology computes a 2-D convolution of an image with a 3×3 kernel using only synthetic neurons with 2 synapses.

For a test case a chip with 4 neurons, each of which has 2 synapses, was used. The neurons are labeled n0, n1, n2 and n3. The inputs and synapse weights of each neuron are configured by an FPGA. Each neuron will be used for multiple calculations, and the intermediate results will be stored in the FPGA to be passed as inputs to the next cycle of calculations.

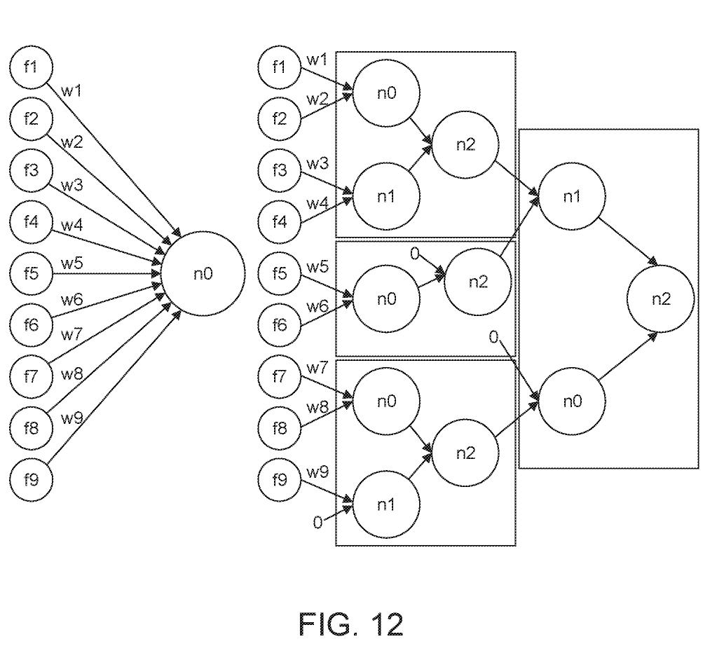

To replicate the function of a single 9 synapse neuron, a tree of 2 synapse neurons is built, as shown in FIG. 12. Adding 4 inputs requires 3 neurons. For ease of tracking inputs, one uses only 3 neurons (n0, n1, and n2) of the 4 neuron chip at a time. Each of the 4 square boxes represents one cycle of calculations. Four cycles would be needed to calculate the 2-D convolution of a single pixel of the image. The FPGA is used to configure the synthetic neurons to perform this convolution for each pixel and record those results.

For each pixel, one first determines the synapse tracking weights and inputs for each neuron based on the location of the pixel in the image and the convolution kernel. Due to edge effects, neuron inputs need to be duplicated if the filter kernel is run on edge or corner pixels. The inputs for each element of the kernel operating on a corner or edge of the image are listed below.

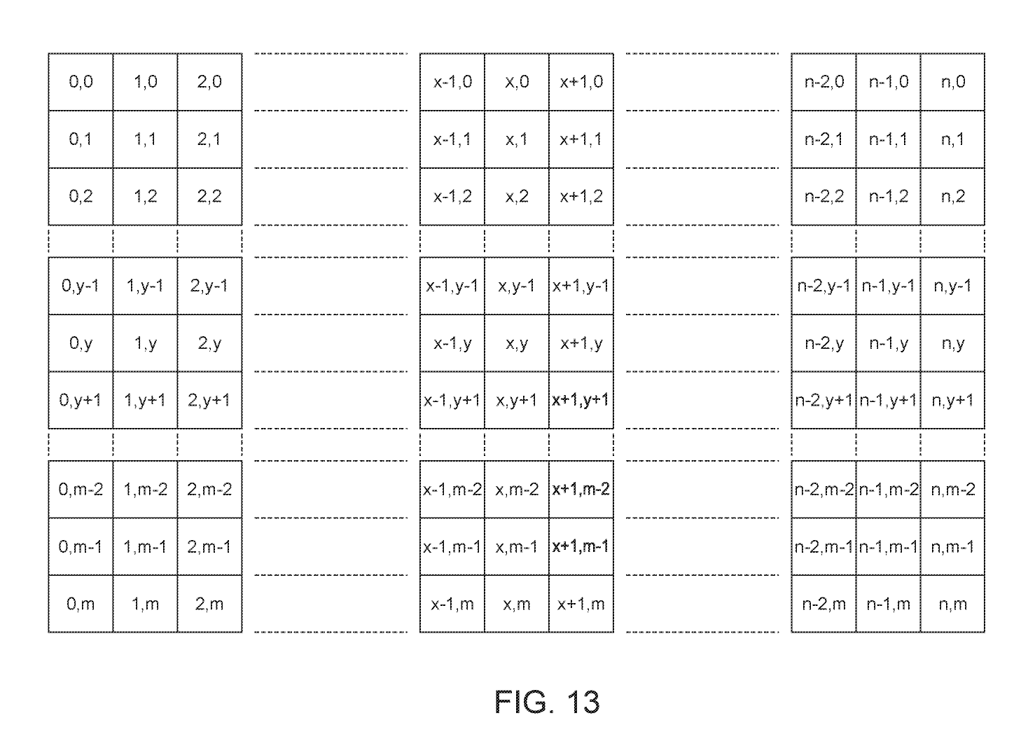

FIG. 13 shows the pixel numbering scheme for explaining convolution using a 3×3 convoluting kernel. The corner pixels are: p_{0,0}=upper left; p_{n,0}=upper right; p_{0,m}=lower left; and p_{n,m}=lower right. In general, p_{i,j}=pixel on the iₜₕ column (1 through n) and jₜₕ row (1 through m).

For clarity, p is omitted in FIG. 13 and only the pixel indices are noted.

The side pixels for xₜₕ column will be represented as follows: p_{x,0}=top and p_{x,m}=bottom. The side pixels for the yₜₕ row are p_{0,y}=left and p_{n,y}=right.

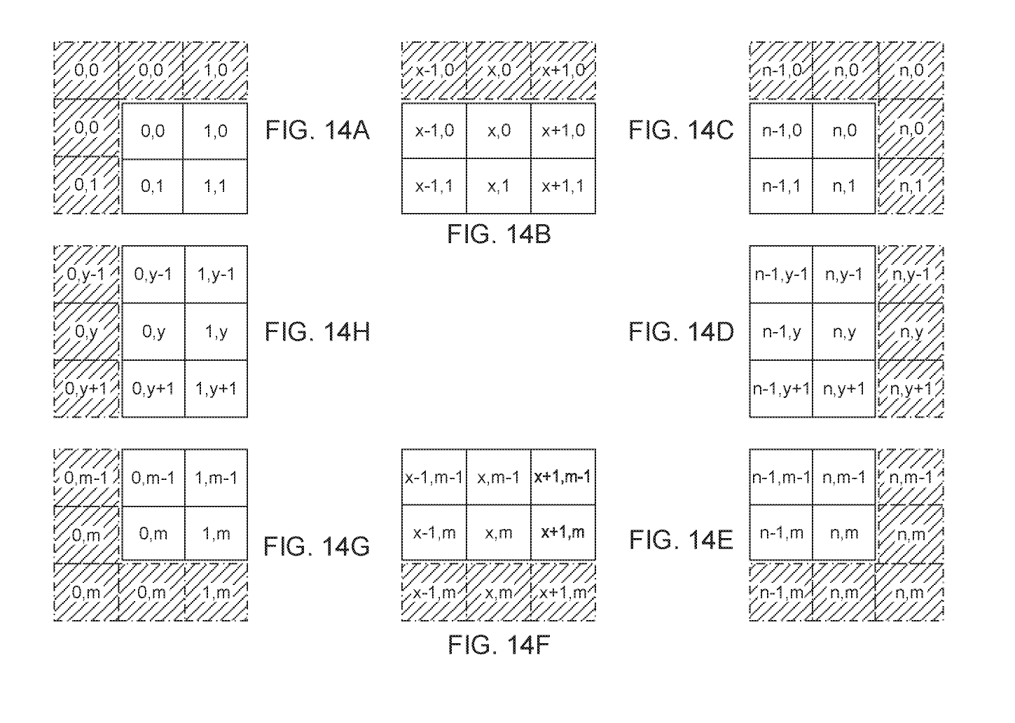

FIGS. 14A-14H show pixel duplications (i.e., extra pixels not part of the image) for a 3×3 kernel for pixels at the corners and sides. The shaded pixels with dashed boxes are introduced to fill the 3×3 kernel although they are not part of the image. Below each row (3 rows with 3 column values) is separated by a semicolon (;).

Upper left (FIG. 14A): p_{0,0}, p_{0,0}, p_{1,0}; p_{0,0}, p_{0,0}, p_{1,0}; p_{0,1}, p_{0,1}, p_{1,1}.

Upper right (FIG. 14C): p_{n-1,0}, p_{n,0}, p_{n,0}; p_{n-1,0}, p_{n,0}, p_{n,0}; p_{n-1,1}, p_{n,1}, p_{n,1}.

Lower left (FIG. 14G): p_{0,m-1}, p_{0,m-1}, p_{1,m-1}; p_{0,m}, p_{0,m}, p_{1,m}; p_{0,m}, p_{0,m}, p_{1,m}.

Lower right (FIG. 14E): p_{n-1,m-1}, p_{n,m-1}, p_{n,m-1}; p_{n-1,m}, p_{n,m}, p_{n,m}; p_{n-1,m}, p_{n,m}, p_{n,m}.

Top, column. x (FIG. 14B): p_{x-1,0}, p_{x,0}, p_{x+1,0}; p_{x-1,0}, p_{x,0}, p_{x+1,0}; p_{x-1,1}, p_{x,1}, p_{x-1,1}.

Bottom, column x (FIG. 14F): p_{x-1,m-1}, p_{x,m-1}, p_{x+1,m-1}; p_{x-1,m}, p_{x,m}, p_{x+1,m}; p_{x-1,m}, p_{x,m}, p_{x+1,m}.

Side left, row y (FIG. 14H): p_{0,y-1}, p_{0,y-1}, p_{1,y-1}; p_{0,y}, p_{0,y}, p_{1,y}; p_{0,y+1}, p_{0,y+1}, p_{1,y+1}.

Side right, row y (FIG. 14D): p_{n-1,y-1}, p_{n,y-1}, p_{n,y-1}; p_{n-1,y}, p_{n,y}, p_{n,y}; p_{n-1,y+1}, p_{n,y+1}, p_{n,y+1}.

Initially, all 9 inputs were added pair-wise without regards the synapse weights being inhibitory or excitatory. However, this led to cases where a large inhibitory input was added to a small excitatory input, resulting in an output of 0 as the neurons are incapable of outputting negatives. This introduced a large amount of error. This was corrected for by sorting the inputs into inhibitory or excitatory, and performed pair-wise addition on each type of input separately. For this addition, all inhibitory inputs were treated as excitatory. Only in the final step the inhibitory inputs were negated and subtraction is performed. This ensures that that large inhibitory inputs are not masked by addition with small excitatory inputs.

Each addition through a neuron also introduced a scale factor, indicated by square brackets in Eq. 9, to the output. Under the operating conditions of the chip, the scale factor equaled approximately 0.18. As the tree structure required passing an input through multiple neurons, this reduced the output magnitude by up to 104. To compensate for this, an inverse scale factor (rounded to the nearest integer) was introduced through the FPGA, and multiplied all intermediates by this factor. To ensure that all inputs are subject to the same number of scalings, the pair-wise addition tree was rebuilt such that each input passes through 4 neurons.

In addition, the synthetic neurons reported high spike counts than expected when given lower synapse weights. In these cases, the error caused by higher spike counts was compensated by decreasing the compensating scale factor. Given the following weight selections, the scaling factors for the output of the neuron are as follows:
Input WSEL: 0x8080, 0x80FF, 0xFF80: Scale by 3
Input WSEL: 0xC080, 0x80C0: Scale by 4
Input WSEL: 0xE080, 0x80E0, 0xC0C0: Scale by 5
All others, scale by 6

Additionally, a bias was found in the subtraction operation as performed by the synthetic neurons. When adding an excitatory input and an inhibitory input, the neuron requires the sinking inhibitory output to be larger than the sourcing excitatory input to produce a result of 0. At the final subtraction, the excitatory input must be scaled down to get an accurate output. This was compensated for by using the variance in the performance of the 4 neurons on the chip. Neuron n1, when given an input of between 3300 and 5000 spikes in 2 ms, undercounts by 15-20%. Final addition of the excitatory inputs was routed through this neuron to scale down the output in relation to the output from the addition of the inhibitory outputs. The residual bias left after this adjustment was removed in post-processing of the image by subtracting a constant from all recorded FPGA outputs.

While this invention has been particularly shown and described with references to preferred embodiments thereof, it will be understood by those skilled in the art that various changes in form and details may be made therein without departing from the scope of the invention encompassed by the appended claims.

What is claimed is:

1. A neuromorphic system for processing signals from a sensor, comprising:
a synapse; and
a neuron that receives a current from the synapse and produces a frequency output.

2. The system of claim 1, wherein the synapse is controlled by a bias voltage.

3. The system of claim 1, wherein the synapse receives a current from a photodetector.

4. The system of claim 3, wherein the synapse or neuron is controlled by a second sensor.

5. The system of claim 1, further comprising multiple synapses feeding into the same neuron.

6. The system of claim 1, wherein the neuron comprises a capacitor that is charged by the current from the synapse.

7. The system of claim 1, further comprising a comparator that compares the voltage on the capacitor to a threshold voltage and resets the capacitor based on a comparison of the threshold voltage with the voltage of the capacitor.

8. The system of claim 1, further comprising multiple neuromorphic circuit elements, having synapse and neurons, that receive inputs from a single image sensor.

9. The system of claim 1, wherein the neuromorphic circuit elements can have multiple reinforcing or inhibiting inputs such as from an imaging and sound systems.

10. The system of claim 1, further comprising collecting the frequency outputs from multiple neurons and performing a convolution.

11. The system of claim 1, wherein the convolution is performed on the output of an image sensor.

12. A method for embedding in an integrated circuit chip a neuromorphic architecture comprising:
providing multiple neuromorphic circuit elements; and
performing a convolution with the circuit elements.

13. The method of claim 12, wherein the neuromorphic circuit elements can have multiple synapses representing inputs from a single image sensor.

14. The method of claim 12, wherein the neuromorphic circuit elements can have multiple reinforcing or inhibiting inputs such as from an imaging and sound systems.

15. A method of embedding an algorithm into a neuromorphic architecture comprising:
providing a desired algorithm, and generating a hardware-optimized algorithm;
generating a neuron-optimized algorithm;
providing a Verilog description of chip design obtained from neural network definition of neuron-optimized algorithm, which in turn is obtained from the hardware-optimized algorithm.
